(19) United States
(12) Patent Application Publication
(10) Pub. No.: US 2005/0187961 A1
(43) Pub. Date: Aug. 25, 2005

(54) Guest data management method and apparatus for navigation system

(76) Inventors: Tatsuo Yokota, Torrance, CA (US); Joanna Sagami, Torrance, CA (US)

Correspondence Address: MURAMATSU & ASSOCIATES, Suite 225, 7700 Irvine Center Drive, Irvine, CA, 92618, US

(21) Appl. No.: 10/782,167

(22) Filed: Feb. 19, 2004

(51) Int. Cl. G06F 7/00

(52) U.S. Cl. 707/102

(57) ABSTRACT

A guest data management method and apparatus for a navigation system is capable of creating, editing and using a guest database storing various types of information regarding guests, tour destinations associated with the guests, and comments by guests or user regarding the destinations, etc., for use with a navigation system. The guest data management method includes the steps of creating a guest database which stores at least information on guests and information on destinations associated with the guests; editing the guest database by modifying the information stored in the database or adding new information to the database; and retrieving information from the guest database for determining a destination for a travel with one of the guests whose information is stored in the database.

### FIELD OF THE INVENTION

This invention relates to a data management method and apparatus for a navigation system, and more particularly, to a data management method and apparatus for creating, editing and using a guest database storing various types of information regarding guests, tour destinations associated with the guests, and comments by guests or user regarding the destinations, etc., for use with a navigation system.

### BACKGROUND OF THE INVENTION

A navigation system, typically a vehicle navigation system, performs travel guidance for enabling a user to easily drive the vehicle to a selected destination. Such a navigation system detects the position of the user, reads out map data pertaining to an area at the user's current position (current vehicle position) from a data storage medium, for example, a CD-ROM (compact disk read-only memory) or a DVD (digital versatile disc). For example, the vehicle current position is determined by a combination of self-contained navigation sensors mounted in the vehicle and a global positioning system (GPS) including a GPS satellite.

FIGS. 1A-1H show an example of overall procedure and screen display involved in the vehicle navigation system. It should be noted that the present invention can also be applied to a portable navigation device such as a one implemented by a PDA (personal digital assistant) device, a lap-top computer, or other hand-held devices. However, for the simplicity of explanation, the present invention is described mainly for the case of vehicle navigation system.

FIG. 1A shows an example of locator map screen of the navigation system typically used when a destination is not specified. The navigation system displays a street on which the vehicle (current vehicle position VP) is running on a map image and a name of the street. FIGS. 1B-1F show an example of process for specifying a destination in the navigation system. When selecting a “Destination” menu on a main menu screen of FIG. 1B, the navigation system displays an “Find Destination By” screen as shown in FIG. 1C for specifying an input method for selecting the destination. The “Find Destination By” screen lists various methods for selecting the destination, which include “Address”, “Intersection”, “Point of Interest (POI)”, “Recent Route”, “Address Book”, and “Today's Plan”.

When selecting, for example, the “Address” method or “Today's Plan” method in FIG. 1C, the navigation system displays a keyboard screen in FIG. 1D. Suppose the user inputs an address or a place name of the destination, the navigation system displays a “Confirm Destination” screen such as shown in FIG. 1E. If the name and address on the screen shows the correct destination that the user wants to go, the user presses an “OK to Proceed” key to proceed to the next procedure.

In FIG. 1F, the navigation system calculates and determines a route to the destination. The navigation system determines a route to the destination based on, for example, the quickest way to reach the destination, the route using as many freeways as possible, or the route without using toll road, or the like. Once the route to the destination is determined, the navigation system starts the route guidance as shown in FIG. 1G for guiding the user to the destination. Typically, the navigation system shows an intersection that is highlighted on the display to show the next turn and a direction of the turn. When the user approaches the destination within a predetermined distance, the navigation system indicates that the destination is ahead as shown in FIG. 1H.

In setting the destination, in the foregoing procedure, the user may select a particular destination by selecting a point of interest (POI) from a list of POIs on the display or by selecting a previously visited destination from a list of recent destinations recorded in the navigation system. In many cases, a user wants to entertain his guests, friends, or relatives by visiting restaurants, golf courses, theaters and the like. In such an occasion, the navigation system can be advantageously used to visit previously visited places by recording the information regarding the prior travels.

In the conventional navigation system, however, although the system records the list of recent destinations in the “Recent Route” input method noted above, it is not possible to make use of additional information on the guest, since the navigation system only records the name and address of the previously visited destinations. In some cases, it is necessary to avoid a certain location for a particular guest. For instance, the guest may have disliked a certain restaurant and does not wish to dine there again, or the restaurant may be frequented by the user's other guests who happen to be from a rival company of the particular guest. For a user who entertains guests frequency, in the conventional technology, it is difficult to keep track of the preferences of each guest.

Accordingly, there is a need for a navigation system having the function to store destination list and guest record to help the user to select appropriate destinations for each guest, associated circumstances and conditions.

### SUMMARY OF THE INVENTION

It is, therefore, an object of the present invention to provide a guest data management method and apparatus for a navigation system which is capable of recording, editing, and retrieving the guest data to assist planning and deciding a destination for a particular guest.

It is another object of the present invention is to provide a guest data management method and apparatus which is capable of producing a tour destination list and a guest visit record for a navigation system where the location data can be automatically registered by the navigation system, and the guest data and destination evaluation data are manually registered by the user.

It is a further object of the present invention is to provide a guest data management method and apparatus for navigation system which is capable of creating and editing the database related to particular goods or services such as real estate business, and retrieving the relevant data associated with the particular goods and services.

A guest data management method and apparatus for a navigation system is capable of creating, editing and using a guest database storing various types of information regarding guests, tour destinations associated with the guests, and comments by guests or user regarding the destinations, etc., for use with a navigation system. The guest data management method includes the steps of creating a guest database which stores at least information on guests and information on destinations associated with the guests; editing the guest database by modifying the information stored in the database or adding new information to the database; and retrieving information from the guest database for determining a destination for a travel with one of the guests whose information is stored in the database.

Another aspect of the present invention is a guest data management apparatus for implementing the various steps defined in the method noted above. The guest data management apparatus includes means for creating a guest database which stores at least information on guests and information on destinations associated with the guests; means for editing the guest database by modifying the information stored in the database or adding new information to the database; and means for retrieving information from the guest database for determining a destination for a travel with one of the guests whose information is stored in the database.

According to the guest data management method and apparatus of the present invention, the navigation system allows the user to extract the places visited with a particular guest by first entering the name of the guest or select the name from the guest name list. The next time the user has to guide the same guest, the information regarding the previous reception has already been entered and the user can make an informed decision as to which place is most suitable for the guest.

### BRIEF DESCRIPTION OF THE DRAWINGS

FIGS. 1A-1H are schematic diagrams showing an example of process and screen display of a navigation system for specifying one or more destinations, determining a route to the destination, and guiding the user to the destination.

FIG. 2 is a block diagram showing an example of structure in a vehicle navigation system for implementing the guest data management method and apparatus of the present invention.

FIG. 3 is a functional block diagram showing a basic structure of the guest data management apparatus of the present invention.

FIGS. 4A-4H are schematic views showing guest travel data, their categories, and relationship with one another for use with the guest data management method and apparatus of the present invention.

FIGS. 5A-5C are schematic diagrams showing display examples of the present invention where guest information to be edited or entered are categorized into a plurality of categories and activities from which a user can select one of them for data entry and retrieval.

FIGS. 6A-6D are schematic diagrams showing display examples of the present invention in which FIG. 6A shows data entries for guest information, FIG. 6B shows data entries for destination attribute, FIG. 6C shows data entries for occasion information, and FIG. 6D shows data entries for route attributes.

FIGS. 7A-7B are schematic diagrams showing display examples in the present invention where a user inputs information for guest visit record in which 7A shows an example of keyboard display for inputting the name of the guest, and FIG. 7B shows an example of keyboard display for inputting the impression on the destination.

FIGS. 8A-8F are schematic diagrams showing an operational process and display examples in the navigation system for retrieving relevant information on destinations from the database created by the guest data management apparatus of the present invention.

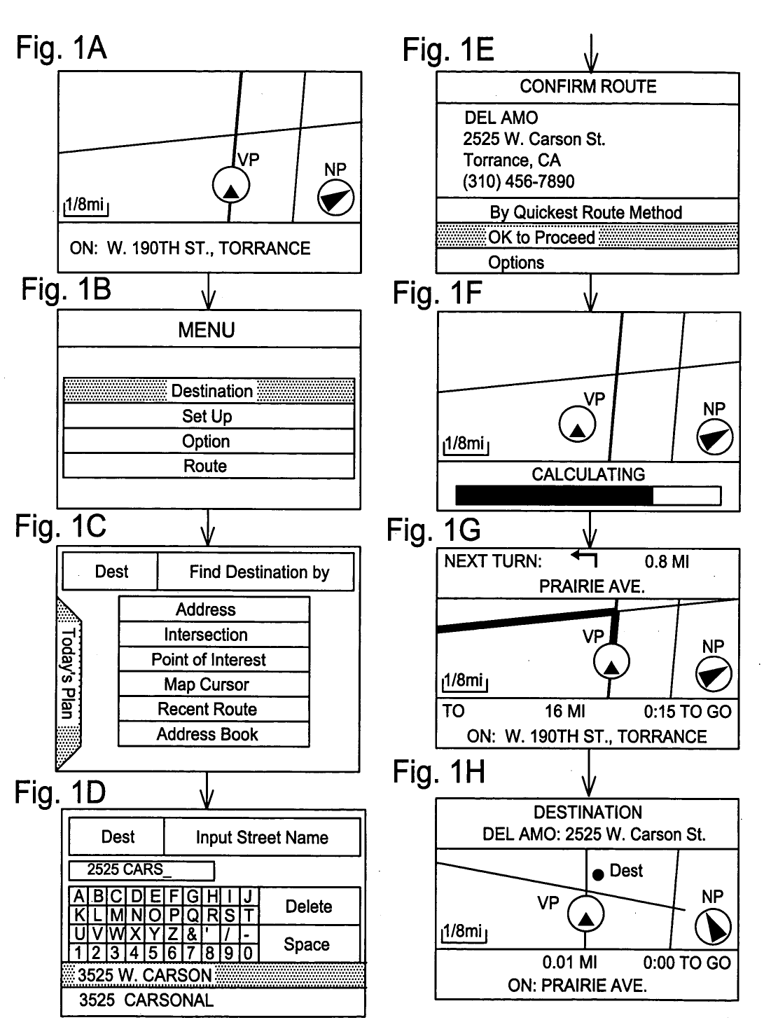

### DETAILED DESCRIPTION OF THE INVENTION

The present invention will be described in detail with reference to the accompanying drawings. The guest data management method and apparatus is implemented in a navigation system of the present invention which is designed to enable a user to establish, edit and retrieve guest data for traveling and entertaining a guest. In order to achieve this goal, the navigation system includes means for collecting information on a guest and his destination based on a prior experience of taking the guest to the destination, thereby creating a guest database. The user adds the information to the guest database based on his personal impression, guest's comments, drivers and other person's comments regarding the destinations. The user adds the information regarding the destination based on his own experience of visiting the destination. The guest data management apparatus is designed to allow the user to edit and extract information from the guest database in terms of particular guest, destination, etc.

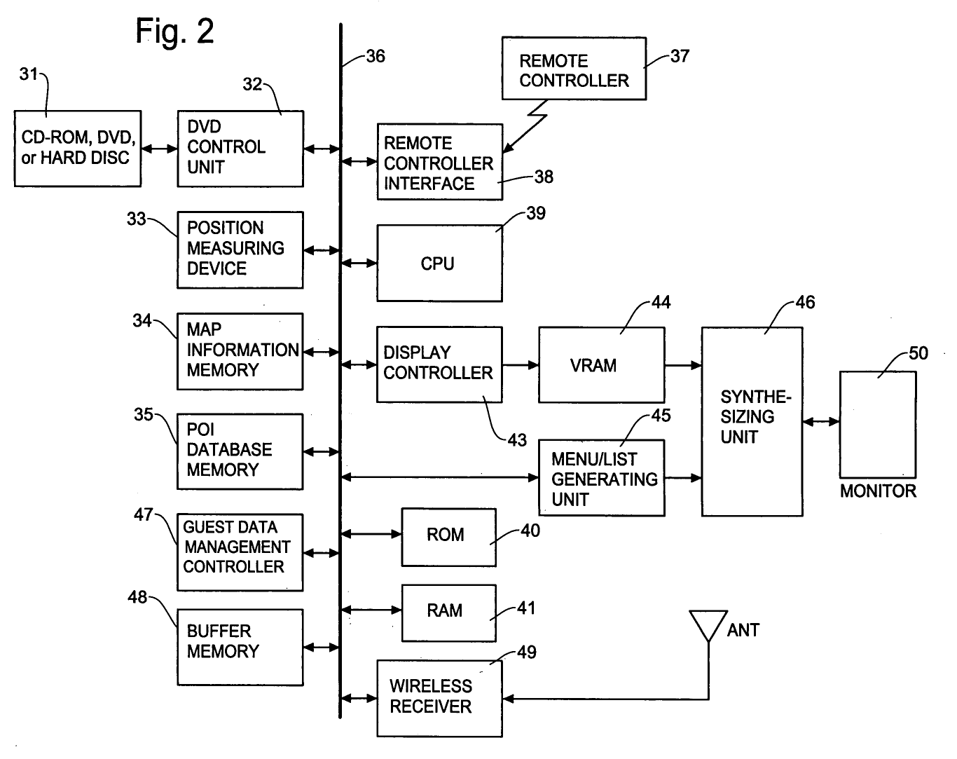

FIG. 2 shows an example of structure of a vehicle navigation system implementing the present invention. It should be noted that the present invention can also be applied to a portable navigation device such as a one implemented by a PDA (personal digital assistant) device, a lap-top computer, or other hand-held devices.

In the block diagram of FIG. 2, the navigation system includes a map storage medium 31 such as a CD-ROM, DVD, hard disc or other storage means (hereafter “DVD”) for storing map information, a DVD control unit 32 for a controlling an operation for reading the map information from the DVD, a position measuring device 33 for measuring the present vehicle position. The position measuring device 33 has a vehicle speed sensor for detecting a moving distance, a gyroscope for detecting a moving direction, a microprocessor for calculating a position, a GPS receiver, and etc.

The block diagram of FIG. 2 further includes a map information (data) memory 34 for storing the map information which is read out form the DVD 31, a database memory 35 for storing database information such as point of interest (POI) information which is read out from the DVD 31, a remote controller 37 for executing a menu selection operation, an enlarge/reduce operation, a destination input operation, etc. and a remote controller interface 38.

The navigation system further includes a bus 36 for interfacing the above units in the system, a processor (CPU) 39 for controlling an overall operation of the navigation system, a ROM 40 for storing various control programs such as a route search program and a map matching program necessary for navigation control, a RAM 41 for storing a processing result such as a guide route, a display controller 43 for generating map image (a map guide image and an arrow guide image) on the basis of the map information, a VRAM (Video RAM) 44 for storing images generated by the display controller, a menu/list generating unit 45 for generating menu image/various list images, a synthesizing unit 46, a guest data management controller 47, a buffer memory 48, a wireless receiver 49, and a monitor (display) 50.

The guest data management controller 47 performs the essential function of the present invention for assisting the user to create the guest database and sorting the guest data based on various parameters, and reproducing the guest data in response to the user's request. The guest data management controller 47 controls the overall process of the guest data management method and apparatus of the present invention. The buffer memory 48 can be advantageously used for temporarily storing the relevant data for guest data management or establishing the guest database. The traffic information will be supplied from a traffic incident data server directly through the wireless receiver 49 and an antenna or indirectly through public communication networks for accumulating traffic incident data. Various sensors will be incorporated in the navigation system to obtain extended information concerning the destination including conditions surrounding the destination, road surface conditions, atmosphere of the destination, etc.

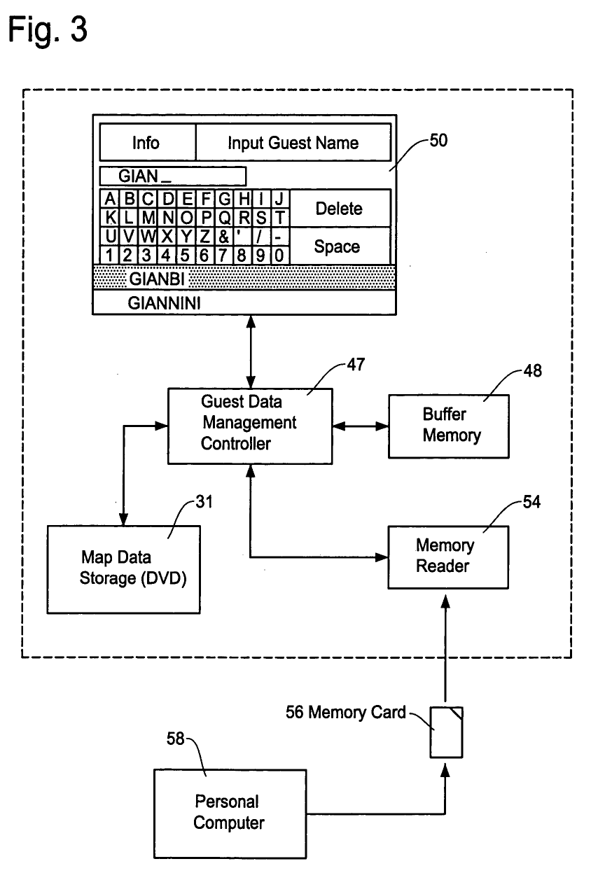

FIG. 3 is a functional block diagram showing an example of basic structure of the guest data management apparatus of the present invention. The structure of FIG. 3 is illustrated by the components in the block diagram of FIG. 2 that are directly related to the operation of the present invention. The major components of the guest data management apparatus includes the monitor 50 for interfacing with the user, the guest data management controller 47 for controlling an overall operation of the guest data management apparatus, the map data storage 31 such as DVD storing the map data, and the buffer memory 48 for temporarily storing various types of data for operation of the apparatus. The guest data management controller 47 can be implemented by the CPU 39 in FIG. 2 or by a separate controller such as a microprocessor. Further, the buffer memory 48 can be implemented by RAM 41 or other memory without using a separate memory.

The block diagram of FIG. 3 optionally includes a memory reader 54 for receiving information for creating the guest database through an external memory such as a memory card 56. Since the guest database stores a relatively large volume of data, sometimes it may be convenient for the user to create the guest information for the guest database with use of a personal computer 58 rather than the navigation system. Thus, the memory reader 54 receives the guest information created by the personal computer 58 through the memory card 56 and transfers the received data to the data management controller 47.

When a user visited a certain destination with a guest or without a guest, he inputs personal impression of the destination, guest's comments on the destination, information regarding the guest, etc. in a guest database through the keyboard screen 50 of the navigation system. The navigation system also automatically stores the destination data such as a place name, place type, address, phone number, route, etc. in the guest database. The guest database can be created in the map data storage 31 when the storage 31 is implemented by a hard disc, the buffer memory 48, or other memory. The guest data management controller 47 controls the navigation monitor 50 so that the user can add and edit the guest database and extract guest information from the guest database with use of various parameters. As noted above, the guest information created by other means such as a separate personal computer 58 can be added to the guest database through a small storage medium such as the memory card 56 and the memory reader 54.

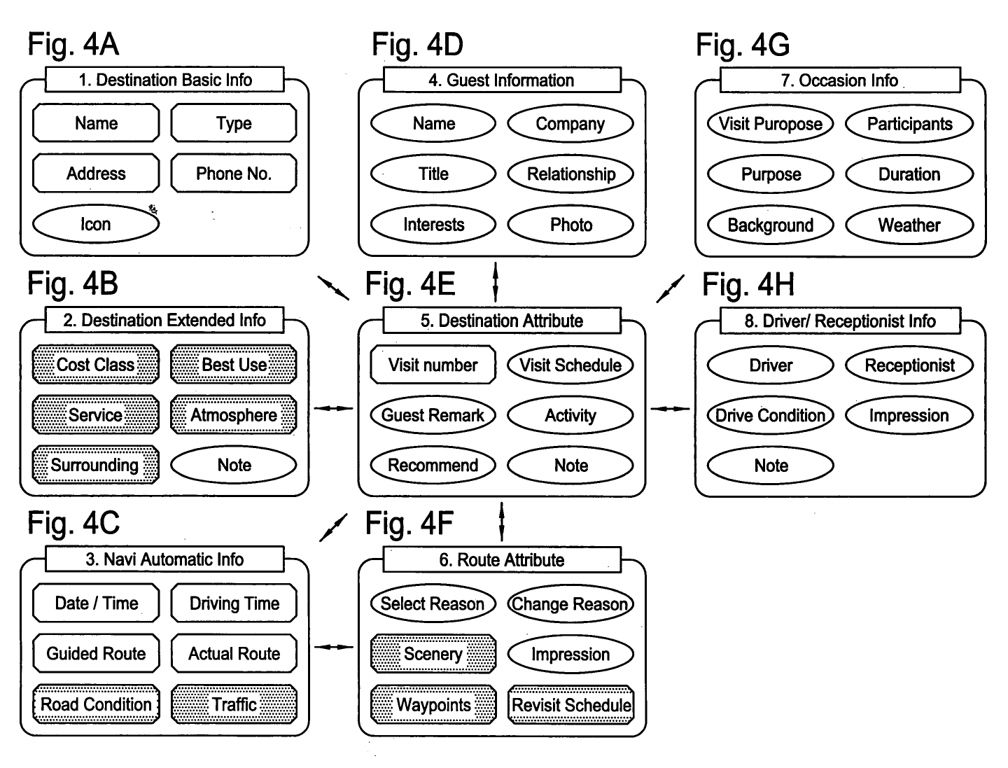

FIGS. 4A-4H schematically show an example of various categories or parameters and relationships among the categories for creating the guest database in the guest data management apparatus of the present invention. Based on these data categories, the user creates the guest database by supplying information obtained through the previous visits to a particular destination with a particular guest or through the user's previous visits without any quest. Other categories of information can be added, or some of the categories of information in this example can be eliminated.

In the diagrams of FIGS. 4A-4H, the categories of information in the plain square boxes such as “Date/time”, “Driving Time”, “Guided Route”, etc., can be obtained automatically by the navigation system. The categories of information in the dotted square boxes concerning the destinations such as “Cost Class”, “Surrounding”, “Traffic”, etc., can be obtained from extended operations of the navigation system having appropriate sensors and wireless communication means. The categories of information in the oval circles concerning guest's information and personal impressions can be manually input by the user.

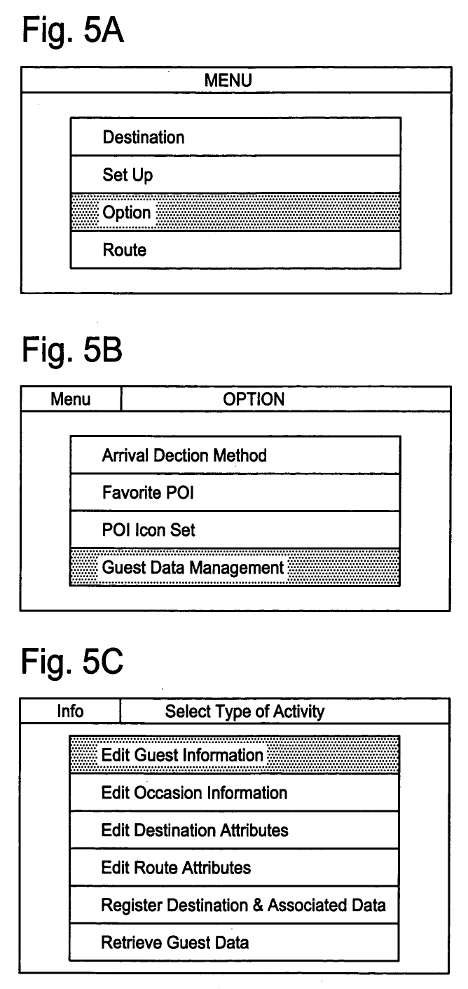

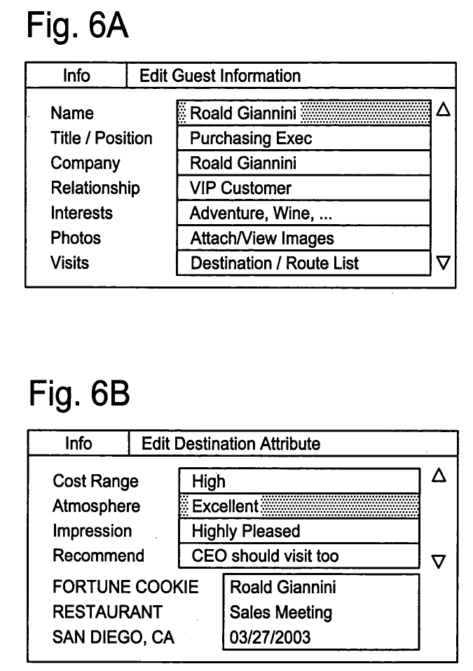

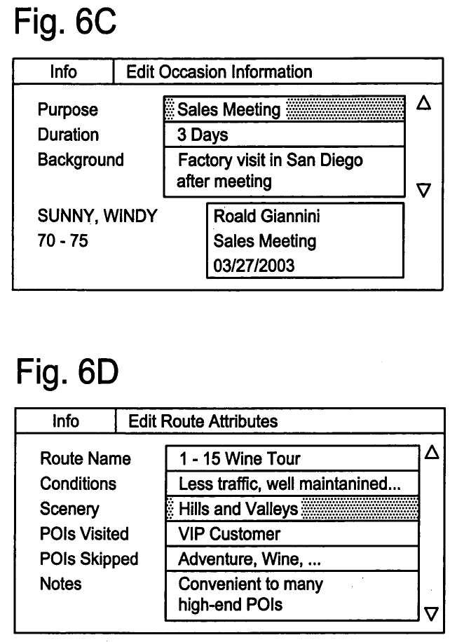

When actually creating the guest database, the navigation system provides processes for creating and updating the guest database as shown in FIGS. 5A-5C and 6A-6D which will be described later. The user selects one or more categories of the guest information and further selects the sub-category in each information category to input the guest information. Further, the navigation system automatically collects the information obtained from the basic as well as extended operations of the navigation system in the guest database. Based on various categories of guest information, the guest database is established and updated in the navigation system to be used later by the user.

FIG. 4A is an example of “Destination Basic Information” which is basic information on a particular destination created by the basic navigation function and inputs by the user. This example lists entry items regarding the destination including a place name (ex. “Fashion Island”), a place type (ex. shopping mall), an address, a phone number, and an icon showing the type of destination. The user selects one or more of the items to input the data on the destination for the selected item, and the navigation system automatically collects and registers the data based on the basic navigation operations, to fill-in the basic information on the destination.

FIG. 4B is an example of “Destination Extended Information” which is extended information on the particular destination in addition to the basic information supplied in the example of FIG. 4A. This example lists entry items regarding the destination including a cost class or range (ex. high, middle, low), contents of service offered in the destination, atmosphere of the destination (ex. excellent, good, poor), surrounding (close to airport, ocean view, etc.), and a note for special comments and information.

FIG. 4C is an example of data categories “Automatic Record Information” through which the navigation system automatically records the information associated with the destination regarding the selected items. This example lists recording items regarding the previous visit to the destination including a day and time, a driving time, a guided route, an actual route when the user drove the route different from the guided route, a road condition such as an unpaved road surface, and a traffic condition such as traffic jam, accident, etc. The information regarding the road condition and the traffic condition may be automatically recorded in a case where the navigation system has sensors and a wireless receiver to retrieve such information.

FIG. 4D is an example of “Guest Personal Information” through which the user inputs information on a particular guest. This example lists entry items regarding the guest including a name of the guest, a name of the company the guest is working for, a title and position of the guest in the company, a relationship with the user, a hobby and interest, and a photograph of the guest. The user selects one of the entry items and input the data on the particular destination and repeats this process for other items to fill-in the guest personal information.

FIG. 4E is an example of “Destination Visit Information” which is specific information on the destination base on the previous visit to the destination. Unlike the generic information on the destination stored in the process of FIGS. 4A and 4B, the example of FIG. 4E lists the specific information on the particular destination. This example lists entry items regarding the destination including a number of times of visiting the destination, a schedule for next visit, comments by the guest regarding the destination, records of activities at the destination, recommendation to others, and a note regarding special comments and impressions. The user selects one of the items to input the specific data on the selected destination and repeats this process for other items to fill-in the specific information on the destination.

FIG. 4F is an example of “Route Attribute Information” which is additional information on the route to the particular destination. The information supplied to the database in this process is additional to the data automatically recorded by the navigation system through the process of FIG. 4C. This example lists entry items regarding the destination including a reason for selecting the particular route to the destination, a reason for changing the route, scenery along the route, impression by a guest, names of waypoints, and a schedule of next visit to the destination.

FIG. 4G is an example of “Guest Attended Information” which is information regarding a particular occasion for attending and entertaining the guest at the destination. This information is to add the information regarding the particular occasion for receiving and entertaining the guest at the particular destination. This example lists entry items including a purpose of visiting the destination, a purpose of entertaining the guest, a duration of staying at the destination, background for receiving the guest, and weather on the days of visit, etc.

FIG. 4H is an example of “Driver and Receptionist Information” which is information derived from a driver and a person who received the particular guest when visiting the particular destination. This information is to add the information by the driver and a person in charge of receiving the guest regarding the particular occasion for receiving and entertaining the guest at the particular destination. This example lists entry items including a name of the driver, a name of the person receiving the guest, a driving condition, impression by the receptionist, and a special note. The user selects one of the items to input the additional information regarding the guest entertainment at the destination and repeats this process for other items to fill-in the specific information regarding this category.

As indicated by arrows in FIGS. 4A-4H, those categories are related with one another as shown by the arrows therein so that an entry in a particular category is effectively connected to the other entry in another category. For instance, the name of the guest in the guest information category is related to the name of a destination in the destination basic information category. The user is able to find the destination relevant to the guest's name. The data categories for the guest database having tour destination lists and guest visit records are not limited to those shown in FIGS. 4A-4H and may take other data categories.

The procedure to create the guest database in the guest data management method and apparatus of the present invention is explained with reference to display examples of FIGS. 5A-5C and 6A-6D. FIGS. 5A-5C are display examples of the navigation system of the present invention wherein the user selects which category of data or activity to be selected. FIGS. 6A-6D are display examples of the navigation system of the present invention wherein the user selects the category of guest data in the process of FIG. 5C to edit the information. It should be noted that the displays in FIGS. 5A-5C and 6A-6D are shown only for an illustration purpose, thus, various other ways of displaying the functions of the navigation system are possible in an actual implementation of the present invention.

FIG. 5A shows an example of display of the navigation system which is a main menu screen to select one of the basic function of the system. In this example, to edit the guest data management function, the user selects an “Option” screen in the main menu. FIG. 5B shows an option menu which is a list of items concerning the optional function and selection method for use in the navigation system. In the example of FIG. 5B, to created or retrieve the guest data for the navigation system, the user selects “Guest Data Management” in the option menu.

In response, the navigation system displays a “Select Type of Activity” screen shown in FIG. 5C for the user selects one of the activities involved in the guest data management. In this example, the type of activities include “Edit Guest Information”, “Edit Occasion Information”, “Edit Destination Attributes”, “Edit Route Attributes”, “Register Destination and Associated Data”, and “Guest Data Retrieval”. The first four activities are directed to the process for creating, modifying, and adding the guest data. The activity “Register Destination and Associated Data” is to instruct the navigation system to automatically record the current destination and associated data in the guest database. The last activity “Guest Data Retrieval” is directed to the process for retrieving the guest data. It should be noted that the types of activities are not limited to those shown in FIG. 5C.

FIGS. 6A-6D are schematic diagrams showing display examples of the present invention for editing a selected category of guest data. FIG. 6A is a display example of the navigation system of the present invention where the user has selected “Edit Guest Information” in the activity selection screen of FIG. 5C. In this process, the user creates and edits the information regarding a particular guest based on a prior visit to a particular destination. In this example, the items of the guest information include a name of a guest, a company of the guest, title and position of the guest in the company, relationship with the user, guest's interests such as hobbies, photos of the guest, records of previous destinations and the routes to the destinations. The photo data are preferably produced by a digital camera or the like and stored in the guest database to reproduce the image of the guest.

FIG. 6B is a display example of the navigation system of the present invention where the user has selected the “Edit Destination Information” activity from the display in FIG. 5C. In this process, the user creates and edits the information on the destination based on the past experience in visiting the destination. In this example, several attributes regarding the destination are listed. Namely, the display lists a cost range (high, middle, low) at the destination, atmosphere on the way to the destination as well as at the destination, impression such as comments by the guest, recommendation related to the destination, name, address, and type of the destination.

FIG. 6C is a display example of the navigation system of the present invention when the user has selected the “Edit Occasion Information” activity from the display in FIG. 5C. In this process, the user creates and edits the information on the occasion in receiving and entertaining the guest at the particular destination. In this example, several attributes of the occasion information is listed. Namely, the display lists the purpose of the visit, duration of visit, background of visiting the destination with the guest, weather and temperature at the time of the visit, etc.

FIG. 6D is a display example of the navigation system of the present invention when the user has selected the “Edit Route Attributes” activity from the display in FIG. 5C. Several attributes of the guest information are listed in FIG. 6D. The display lists the route name, condition of the route, scenery encountered in following the route, points of interest visited in the route, etc. The user may enter personal notes to record additional information. It should be noted that the entries in FIG. 6A to 6D are not limited to those shown on the display, and other entries relating to the category may also be included.

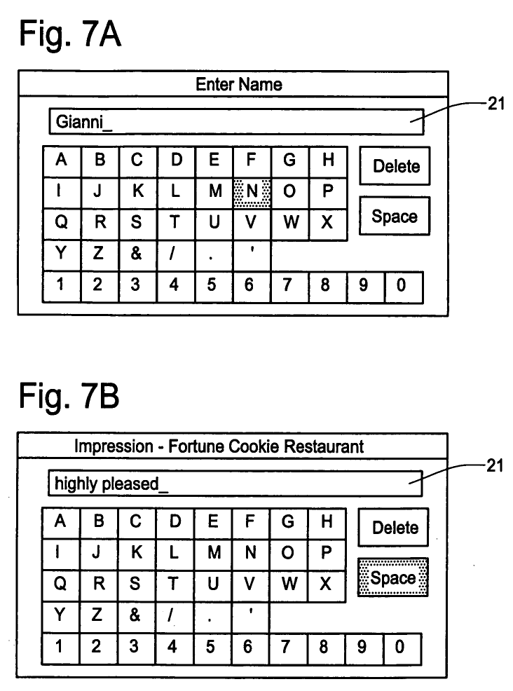

FIG. 7A and FIG. 7B show examples of display for entering and editing the guest data. Referring to FIG. 7A, the user can enter a name of the guest, a place name of the destination, a name of the driver, etc., through the keyboard. The characters are displayed in the window 21 every time the selected key is pressed. FIG. 7B shows the example of entering data concerning the impression or comments by the guest, profile and interest by the guest, comments and recommendations by the user with regard to the visit to the particular destination. It is also possible to enter information by other means such as a voice recognition system. As shown in the block diagram of FIG. 3, it is also possible to create such data separately through a personal computer (desktop computer, laptop computer, etc.) and transfer the data to the navigation system through the storage medium such as a memory card.

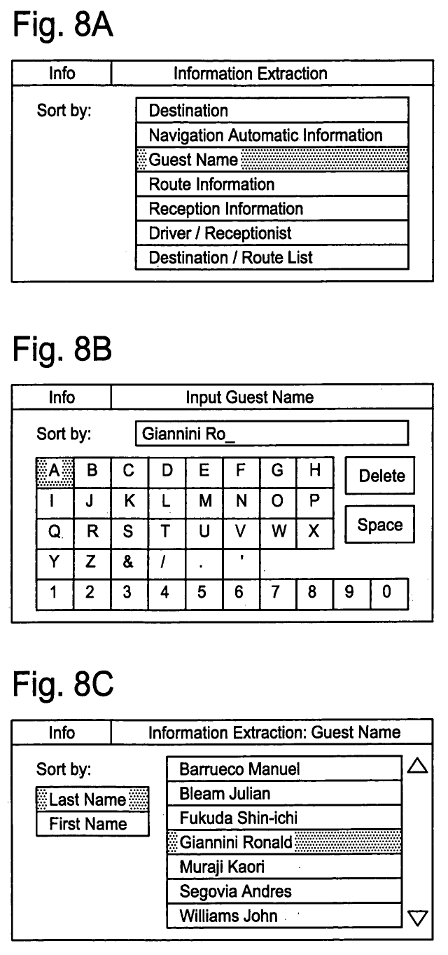

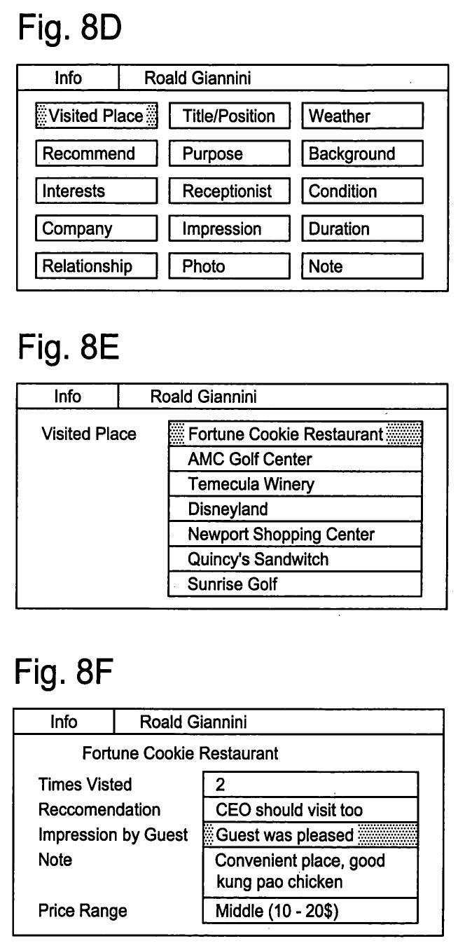

The process of extracting the guest data created in the foregoing process is explained next. This process starts when the user selects the activity “Guest Data Retrieval” in the process of FIG. 5C. FIG. 8A is an example of display showing the information extraction screen in the guest data management apparatus of the present invention. The user selects which information is to be retrieved by specifying an entry in the data category list.

For example, if the user wants to find information on a particular destination, the user can select the destination entry. In this example, seven entries are listed from which the user can select a particular category to extract the information. However, the number and types of entries are not limited by those shown in FIG. 8C and there may be other items in the list from which the user can select to find the pertinent information.

FIG. 8B is an example of information extraction display where the user inputs an entry to find pertinent information. This example shows the case that the user inputs the guest name to be searched through the keyboard on the navigation screen. In this case, the user has input the name “Giannini” to find information relating to this particular guest. Alternatively, as shown in FIG. 8C, the navigation system displays a list of guest names extracted from the guest database. Typically, the guest names are arranged in the alphabetical order, although other orders of arrangement are also possible. Further in this example, the user can select whether the guest names should be sorted by the first name or the last name.

FIG. 8D is an example of display that follows from the display in FIG. 8B or FIG. 8C when the guest name is specified. The screen of FIG. 8D lists various categories of information concerning the specified guest name “Ronald Giannini” including visited places (destinations), purpose and background of the visits, relationship with the user, photograph of the guest, etc. The user can select one or more categories from among the multiple categories to view pertinent information on this guest.

When the user selects one category such as “Visited Places” by highlighting this item, the navigation system displays the information on the visited places relating to the guest as shown in FIG. 8E. Place names that the user (or colleague of the user) has visited with the guest “Ronald Giannini” in the past are listed on the navigation screen. The place names can be listed in the order of time (from most recent to least recent), in the order of frequency (from higher number of visit to lower number of visit), or in the alphabetical order. The user can tell what places the user (or user's associate) has visited with this particular guest. Thus, when the user wishes to visit a restaurant that has been received favorably by the guest in the prior occasions, the user can easily find the particular restaurant even if the user does not recall the exact name or the location of the restaurant.

FIG. 8F shows an example of display when the user selects a place name “Fortune Cookie Restaurant” on the display of FIG. 8E. The example of FIG. 8F lists the number of times that the guest has visited this particular restaurant, impression by the guest, recommendation by the user, price range, etc. The impression by the guest entry tells the user that the guest liked the restaurant. In the case where the user has recorded some personal notes, for example, the restaurant is conveniently located, it plays classical music, it has charming waitresses, etc., the user is able to extract that information as well. When the restaurant has a famous dish or if the guest particularly liked a certain dish, the user may talk to the guest about the dish or related topics. The user may also arrange the reception that is pleasant to the guest by ordering dishes the guest liked in the past.

Because the guest record function of the present invention is incorporated in the navigation system, many procedures for inputting the records to the navigation system can be eliminated, thereby reducing the time required by the user in entering the information. For example, when the user first meets the guest and decides the place to visit, the user can input the location to use the vehicle navigation system. Such data is stored in the guest database of the navigation system automatically or the instruction by the user when selecting the “Register Destination and Associated Data” activity in the example of FIG. 5C, so that the user can utilize the data in the future occasion without newly inputting the same destination.

Upon entering the place to visit, the navigation system can calculate the route to the destination and the user will drive to that location. The navigation system can automatically record the place name, address, the time and date of making the visit to the place. Moreover, the navigation system can record the calculated route as well as the actual route the user took and the time required to reach that destination, etc. When the user enters the next destination, the navigation system of the present invention repeats the procedure described above and adds all the information to the guest database that can be edited and extracted thereafter.

In the guest data management method and apparatus of the present invention, the navigation system allows the user to extract the places visited with a particular guest by first entering the name of the guest or select the name from the guest name list. The next time the user has to guide the same guest, information regarding the previous reception has already been entered and the user can make an informed decision as to which place is most suitable to the guest. Thus, the user needs not to recall the prior experience or to perform complex operations of the navigation system.

The guest data management method and apparatus of the present invention is advantageously applicable to many other situations to entertain a guest. The user may recommend to visit “Magic Mountain” theme park for the guest who enjoyed the visit to the similar type of places such as “Disneyland”, “Universal Studios”, or the like in the previous visits. Alternatively, the user may choose to visit a beach for a change for the guest who has visited theme parks in prior occasions. Because the visited places are stored in the navigation system, the user can quickly respond to the guest's request to visit the restaurant visited in the prior occasions.

Another advantage of the navigation system of the present invention is that it allows to enter visited locations by the vehicle location registration function. For example, when the user finds a small antique store while guiding a guest and visits the store, the user may simply instructs the navigation system to register that location by pressing “Register Destination and Associate Data” menu in FIG. 5C. When the guest wishes to revisit the store, it is easy to recall the location because the user can easily find the location from the list of visited locations with regard to that guest. The location may simply be a place that the user and the guest passed by without actually visiting. In case the user found an antique store at the side of a road but has to forego shopping due to time concern, the user may simply register that location for the next visit with that client in the future.

In the above example, the situation is explained where the user guides a guest. The present invention may also be effectively used by real estate sales persons who guides customers to show listed properties. As is well known, a real estate sales person has to guide many customers to show properties in the market. It is difficult to manage the information regarding what property should be visited by whom in what condition. When a seller still resides in the property, there is often a time limitation to show the house to customers.

The following information may be useful in planning the customer effectively: who has invited to what property; who was interested in what property; the running time to a property; and traffic information of surrounding area of the property. The real estate sales person can record the preference of a customer in the database in the navigation system. The sales person may also make a note with regard to the selling properties and record the note in the database. When a particular property has a nice view, the real estate sales person can take advantage of this information to give good impression on a customer.

For a user who is a door-to-door sales person, he may wish to know unvisited places, places that had long been unvisited, prospective visited places, etc. The user can input such information in the guest data management apparatus of the navigation system. Thus, when necessary, the user can easily retrieve the relevant information as to which places to visit, and the navigation system is able to effectively guide the user to the selected places.

In a further application, a unique POI list may be created by utilizing the present invention. When a user wants to visit a particular fishing spot, the user may input the take of the day. When many records are accumulated, the user may see which fishing spot is suitable for a particular season or time. The POI list may be shared by two or more people so that people not familiar with a route can follow the guided route. The preferred destinations list can be downloaded from third-party suppliers or service provider as well. The list can be categorized for particular interests, such as amusement parks, restaurants, wine country, popular nightlife destinations of the month, seasonal destinations, etc. The present invention is especially effective in a navigation system having a large storage medium such as a hard disc drive.

Thus, the navigation system of the present invention allows to guide a guest to a new location or to plan a new route suited to the guest. Moreover, it allows the user to effectively plan a trip for a particular guest. The user may plan to revisit a particular place or take a particular route that is of interest to the guest by referring to the past records. The user may also plan to visit a place that has not been visited before to entertain the guest.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

1. A guest data management method for a navigation system, comprising the following steps of:
creating a guest database which stores at least information on guests and information on destinations associated with the guests;
editing the guest database by modifying the information stored in the database or adding new information to the database; and
retrieving information from the guest database for determining a destination for a travel with one of the guests whose information is stored in the database.

2. A guest data management method as defined in claim 1, wherein said database includes information as to whether a particular guest is pleased or the guest shows favorable opinion on a particular destination.

3. A guest data management method as defined in claim 1, wherein said database includes information on persons involved in a travel to the destination including a user of the navigation system or a driver of a vehicle used for the travel to the destination.

4. A guest data management method as defined in claim 1, wherein said database includes information created by a user based on personal impression of a particular destination acquired when the user visited the destination or evaluation of the destination by the user.

5. A guest data management method as defined in claim 1, wherein said database includes information created by a user based on impression or opinion expressed by a particular guest when the user and the guest visited the destination.

6. A guest data management method as defined in claim 1, wherein said step of creating the guest database includes a step of storing relevant information through a manual input process made by a user.

7. A guest data management method as defined in claim 1, wherein said step of creating the guest database includes a step of automatically storing information available through a normal operation of the navigation system including a name of a destination, address of the destination, and a time and date of visiting the destination.

8. A guest data management method as defined in claim 1, wherein said step of creating the guest database includes a step of storing information available through an extended function of the navigation system including road condition, traffic condition, or weather condition during a travel to a destination when the navigation system includes appropriate sensors or a wireless communication means to acquire information on such conditions.

9. A guest data management apparatus for a navigation system, comprising:
means for creating a guest database which stores at least information on guests and information on destinations associated with the guests;
means for editing the guest database by modifying the information stored in the database or adding new information to the database; and
means for retrieving information from the guest database for determining a destination for a travel with one of the guests whose information is stored in the database.

10. A guest data management apparatus as defined in claim 9, wherein said database includes information as to whether a particular guest is pleased or the guest shows favorable opinion on a particular destination.

11. A guest data management apparatus as defined in claim 9, wherein said database includes information on persons involved in a travel to the destination including a user of the navigation system or a driver of a vehicle used for the travel to the destination.

12. A guest data management apparatus as defined in claim 9, wherein said database includes information created by a user based on personal impression of a particular destination acquired when the user visited the destination or evaluation of the destination by the user.

13. A guest data management apparatus as defined in claim 9, wherein said database includes information created by a user based on impression or opinion expressed by a particular guest when the user and the guest visited the destination.

14. A guest data management apparatus as defined in claim 9, wherein means for creating the guest database includes means for storing relevant information through a manual input process made by a user.

15. A guest data management apparatus as defined in claim 9, wherein said means for creating the guest database includes means for automatically storing information available through a normal operation of the navigation system including a name of a destination, address of the destination, and a time and date of visiting the destination.

16. A guest data management apparatus as defined in claim 9, wherein said means for creating the guest database includes means for storing information available through an extended function of the navigation system including road condition, traffic condition, or weather condition during a travel to a destination when the navigation system includes appropriate sensors or a wireless communication means to acquire information on such conditions.
